(19) United States
(12) Patent Application Publication
(10) Pub. No.: US 2020/0133586 A1
(43) Pub. Date: Apr. 30, 2020

(54) Mapped Redundant Array of Independent Nodes for Data Storage

(71) Applicant: EMC IP Holding Company LLC, Hopkinton, MA (US)

(72) Inventors: Mikhail Danilov, Saint Petersburg (RU); Yohannes Altaye, Dumfries, VA (US)

(21) Appl. No.: 16/177,285

(22) Filed: Oct. 31, 2018

(51) Int. Cl. G06F 3/06

(52) U.S. Cl. CPC G06F 3/0689; G06F 3/0604; G06F 3/0631; G06F 3/0655

(57) ABSTRACT

A mapped redundant array of independent nodes (mapped RAIN) for data storage is disclosed. A mapped RAIN cluster can be allocated on top of one or more real data clusters. The real data cluster can be N nodes wide by M disks deep. A mapped RAIN cluster can be N′ nodes wide by M′ disks deep, where N′ is less than, or equal to N. Mapping of data storage locations in a mapped RAIN cluster can facilitate use of a real cluster at a different granularity than conventionally administered in a real cluster of storage locations. The size of a mapped RAIN cluster can be adapted based on criteria of a corresponding real cluster system, such as overall space, current usage, customer-centric criteria, etc.

### TECHNICAL FIELD

The disclosed subject matter relates to data storage, more particularly, to mapping storage pools comprising storage devices of at least one array of storage devices.

### BACKGROUND

Conventional data storage techniques can store data in one or more arrays of data storage devices. As an example, data can be stored in an ECS (formerly known as ELASTIC CLOUD STORAGE) system, hereinafter ECS system, such as is provided by DELL EMC. The example ECS system can comprise data storage devices, e.g., disks, etc., arranged in nodes, wherein nodes can be comprised in an ECS cluster. One use of data storage is in bulk data storage. Data can conventionally be stored in a group of nodes format for a given cluster, for example, in a conventional ECS system, all disks of nodes comprising the group of nodes are considered part of the group. As such, a node with many disks can, in some conventional embodiments, comprise a large amount of storage that can go underutilized. As an example, a storage group of five nodes, with ten disks per node, at 8 terabytes (TBs) per disk is roughly 400 TB in size. This can be excessively large for some types of data storage, however apportioning smaller groups, e.g., fewer nodes, less disks, smaller disks, etc., can be inefficient in regards to processor and network resources, e.g., computer resource usage, to support these smaller groups. As such, it can be desirable to have more granular logical storage groups that can employ portions of larger real groups, thereby facilitating efficient computer resource usage, e.g., via larger real groups, but still providing smaller logical groups that can be used more optimally for storing smaller amounts of data therein.

### BRIEF DESCRIPTION OF DRAWINGS

FIG. 1 is an illustration of an example system that can facilitate storage of data in a mapped redundant array of independent nodes, in accordance with aspects of the subject disclosure.

FIG. 2 is an illustration of an example system that can facilitate storage of data via a mapped cluster in a mapped redundant array of independent nodes, in accordance with aspects of the subject disclosure.

FIG. 3 is an illustration of an example system that can enable storage of data in a plurality of mapped clusters via a mapped redundant array of independent nodes, in accordance with aspects of the subject disclosure.

FIG. 4 illustrates an example system that can facilitate constrained storage of data in a mapped redundant array of independent nodes, in accordance with aspects of the subject disclosure.

FIG. 5 illustrates an example system that can facilitate constrained storage of data in a mapped redundant array of independent nodes via a plurality of example mapped clusters, in accordance with aspects of the subject disclosure.

FIG. 6 illustrates an example system that can facilitate storage of data in a mapped redundant array of independent nodes employing storage hardware that can be in different geographic areas, in accordance with aspects of the subject disclosure.

FIG. 7 is an illustration of an example method facilitating storage of data in a mapped redundant array of independent nodes, in accordance with aspects of the subject disclosure.

FIG. 8 illustrates an example method that enables storage of data in a mapped redundant array of independent nodes, in accordance with aspects of the subject disclosure.

FIG. 9 depicts an example schematic block diagram of a computing environment with which the disclosed subject matter can interact.

FIG. 10 illustrates an example block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As mentioned, data storage techniques can conventionally store data in one or more arrays of data storage devices. As an example, data can be stored in an ECS system such as is provided by DELL EMC. The example ECS system can comprise data storage devices, e.g., disks, etc., arranged in nodes, wherein nodes can be comprised in an ECS cluster. One use of data storage is in bulk data storage. Data can conventionally be stored in a group of nodes format for a given cluster, for example, in a conventional ECS system, all disks of nodes comprising the group of nodes are considered part of the group. As such, a node with many disks can, in some conventional embodiments, comprise a large amount of storage that can go underutilized. As such, it can be desirable to have more granular logical storage groups that can employ portions of larger real groups, thereby facilitating efficient computer resource usage, e.g., via larger real groups, but still providing smaller logical groups that can be used more efficiently for storing smaller amounts of data therein.

In an embodiment of the presently disclosed subject matter, a mapped redundant array of independent nodes, hereinafter a mapped RAIN, can comprise a mapped cluster, wherein the mapped cluster comprises a logical arrangement of real storage devices. In a mapped cluster, a real cluster(s), e.g., a group of real storage devices comprised in one or more hardware nodes, comprised in one or more clusters, can be defined so allow more granular use of the real cluster in contrast to conventional storage techniques. In an aspect, a mapped cluster can comprise nodes that provide data redundancy, which, in an aspect, can allow for failure of a portion of one or more nodes of the mapped cluster without loss of access to stored data, can allow for removal/addition of one or more nodes from/to the mapped cluster without loss of access to stored data, etc. As an example, a mapped cluster can comprise nodes having a data redundancy scheme analogous to a redundant array of independent disks (RAID) type-6, e.g., RAID6, also known as double-parity RAID, etc., wherein employing a node topology and two parity stripes on each node can allow for two node failures before any data of the mapped cluster becomes inaccessible, etc. In other example embodiments, a mapped cluster can employ other node topologies and parity techniques to provide data redundancy, e.g., analogous to RAID0, RAID1, RAID2, RAID3, RAID4, RAID5, RAID6, RAID0+1, RAID1+0, etc., wherein a node of a mapped cluster can comprise one or more disks, and the node can be loosely similar to a disk in a RAID system. Unlike RAID technology, an example mapped RAIN system can provide access to more granular storage in generally very large data storage systems, often on the order of terabytes, petabytes, exabytes, zettabytes, etc., or even larger, because each node can generally comprise a plurality of disks, unlike RAID technologies.

In an embodiment, software, firmware, etc., can hide the abstraction of mapping nodes in a mapped RAIN system, e.g., the group of nodes can appear to be a contiguous block of data storage even where, for example, it can be spread across multiple portions of one or more real disks, multiple real groups of hardware nodes (a real RAIN), multiple real clusters of hardware nodes (multiple real RAINs), multiple geographic locations, etc. For a given real cluster, e.g., real RAIN, that is N nodes wide and M disks deep, a mapped RAIN can consist of up to N′ mapped nodes and manage up to M′ portions of disks of the constituent real nodes. Accordingly, in an embodiment, one mapped node is expected to manage disks of different real nodes. Similarly, in an embodiment, disks of one real node are expected to be managed by mapped nodes of different mapped RAIN clusters. In some embodiments, the use of two disks by one real node can be forbidden to harden mapped RAIN clusters against a failure of one real node compromising two or more mapped nodes of one mapped RAIN cluster, e.g., a data loss event, etc. Hereinafter, a portion of a real disk can be comprised in a real node that can be comprised in a real cluster and, furthermore, a portion of the real disk can correspond to a portion of a mapped disk, a mapped disk can comprise one or more portions of one or more real disks, a mapped node can comprise one or more portions of one or more real nodes, a mapped cluster can comprise one or more portions of one or more real clusters, etc., and, for convenience, the term RAIN can be omitted for brevity, e.g., a mapped RAIN cluster can be referred to simply as a mapped cluster, a mapped RAIN node can simply be referred to as a mapped node, etc., wherein ‘mapped’ is intended to convey a distinction from a corresponding real physical hardware component.

In an embodiment, a mapped cluster can be comprised in a real cluster, e.g., the mapped cluster can be N′ by M′ in size and the real cluster can be N by M in size, where N′=N and where M′=M. In other embodiments, N′ can be less than, or equal to, N, and M′ can be less than, or equal to, M. It will be noted that in some embodiments, M′ can be larger than M, e.g., where the mapping of a M real disks into M′ mapped disks portions comprises use of a part of one of the M disks, for example, where 10 real disks (M=10) are mapped into 17 mapped disk portions (M′=17), 11 mapped disk portions (M′=11), 119 mapped disk portions (M′=119), etc. In these other embodiments, the mapped cluster can be smaller than the real cluster. Moreover, where the mapped cluster is sufficiently small in comparison to the real cluster, the real cluster can accommodate one or more additional mapped clusters. In an aspect, where mapped cluster(s) are smaller than a real cluster, the mapped cluster can provide finer granularity of the data storage system. As an example, where the real cluster is 8×8, e.g., 8 nodes by 8 disks, then, for example, four mapped 4×4 clusters can be provided, wherein each of the four mapped 4×4 clusters is approximately ¼th the size of the real cluster. As a second example, given an 8×8 real cluster 16 mapped 2×2 clusters can be provided where each mapped cluster is approximately 1/16th the size of the real cluster. As a third example, for the 8×8 real cluster, 2 mapped 4×8 or 8×4 clusters can be provided and each can be approximately ½ the size of the real cluster. Additionally, the example 8×8 real cluster can provide a mix of different sized mapped clusters, for example one 8×4 mapped cluster, one 4×4 mapped cluster, and four 2×2 mapped clusters. In some embodiments, not all of the real cluster must be comprised in a mapped cluster, e.g., an example 8×8 real cluster can comprise only one 2×4 mapped cluster with the rest of the real cluster not (yet) being allocated into mapped storage space.

Other aspects of the disclosed subject matter provide additional features generally not associated with real cluster data storage. In some embodiments, a mapped cluster can comprise storage space from more than one real cluster. In some embodiments, a mapped cluster can comprise storage space from real nodes in different geographical areas. In some embodiments, a mapped cluster can comprise storage space from more than one real cluster in more than one geographic location. As an example, a mapped cluster can comprise storage space from a cluster having hardware nodes in a data center in Denver. In a second example, a mapped cluster can comprise storage space from a first cluster having hardware nodes in a first data center in Denver and from a second cluster also having hardware nodes in the first data center in Denver. As a further example, a mapped cluster can comprise storage space from both a cluster having hardware nodes in a first data center in Denver and a second data center in Denver. As a further example, a mapped cluster can comprise storage space from a first cluster having hardware nodes in a first data center in Seattle, Wash., and a second data center having hardware nodes in Tacoma, Wash. As another example, a mapped cluster can comprise storage space from a first cluster having hardware nodes in a first data center in Houston, Tex., and a second cluster having hardware nods in a data center in Mosco, Russia.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

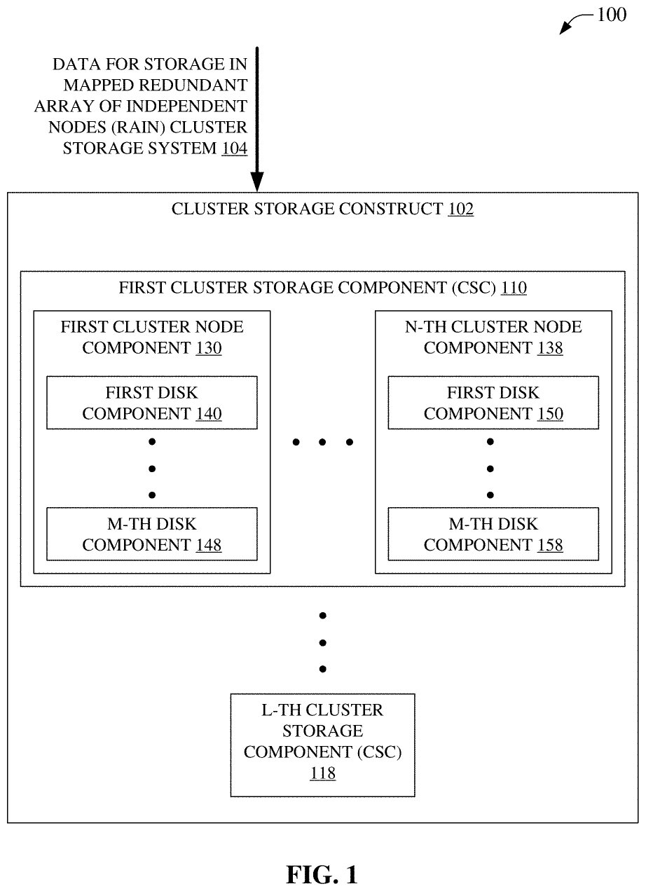

FIG. 1 is an illustration of a system 100, which can facilitate storage of data in a mapped redundant array of independent nodes, in accordance with aspects of the subject disclosure. System 100 can comprise a cluster storage construct 102, which can be embodied in a cluster storage system. In an embodiment, cluster storage construct 102 can be embodied in a real cluster storage system comprising one or more hardware nodes that each comprise one or more storage devices, e.g., hard disks, optical storage, solid state storage, etc. Cluster storage construct 102 can receive data for storage in a mapped cluster, e.g., data for storage in mapped RAIN cluster storage system 104, etc., hereinafter data 104 for brevity. Data 104 can be stored by portions of the one or more storage devices of cluster storage construct 102 according to a logical mapping of the storage space, e.g., according to one or more mapped clusters.

In an aspect, a mapped cluster can be a logical allocation of storage space of cluster storage construct 102. In an embodiment, a portion of a real disk can be comprised in a real node that can be comprised in a real cluster and, furthermore, a portion of the real disk can correspond to a portion of a mapped disk, a mapped disk can comprise one or more portions of one or more real disks, a mapped node can comprise one or more portions of one or more real nodes, a mapped cluster can comprise one or more portions of one or more real clusters, etc. Accordingly, in an embodiment, cluster storage construct 102 can support a mapped cluster enabling data 104 to be stored on one or more disk, e.g., first disk component 140 through M-th disk component 148 of first cluster node component 130 through first disk component 150 through M-th disk component 158 of N-th cluster node component 138 of first cluster storage component (CSC) 110, through disks corresponding to CSCs of L-th cluster storage component 118, according to a mapped cluster schema. In an aspect, a mapped cluster control component, e.g., mapped cluster control component 220-620, etc., can coordinate storage of data 104 on storage elements, e.g., disks, of a real cluster of cluster storage construct 102 according to a mapping of a mapped cluster, e.g., mapped cluster control component 220-620, etc., can indicate where in cluster storage construct 102 data 104 is to be stored, cause data 104 to be stored at a location in in cluster storage construct 102 based on the mapping of the mapped cluster, etc.

In an embodiment, a mapped cluster employing cluster storage construct 102 can be comprised in one or more portions of one or more real cluster, e.g., a portion of one or more disks of first CSC 110-L-th CSC 118, etc. Moreover, the mapped cluster can be N′ nodes by M′ disks in size and the one or more real clusters of cluster storage construct 102 can be N nodes by M disks in size, where N′ can be less than, or equal to, N, and M′ can be less than, or equal to, or greater than, M. In these other embodiments, the mapped cluster can be smaller than cluster storage construct 102. Moreover, where the mapped cluster is sufficiently small in comparison to cluster storage construct 102, one or more additional mapped clusters can be accommodated by cluster storage construct 102. In an aspect, where mapped cluster(s) are smaller than cluster storage construct 102, the mapped cluster can provide finer granularity of the data storage system. As an example, where cluster storage construct 102 is 8×8, e.g., 8 nodes by 8 disks, then, for example, four mapped 4×4 clusters can be provided, wherein each of the four mapped 4×4 clusters is approximately ¼th the size of cluster storage construct 102. As a second example, given an 8×8 cluster storage construct 102, 16 mapped 2×2 clusters can be provided where each mapped cluster is approximately 1/16th the size of cluster storage construct 102. As a third example, for the example 8×8 cluster storage construct 102, two mapped 4×8 or 8×4 clusters can be provided and each can be approximately ½ the size of cluster storage construct 102. Additionally, the example 8×8 cluster storage construct 102 can provide a mix of different sized mapped clusters, for example one 8×4 mapped cluster, one 4×4 mapped cluster, and four 2×2 mapped clusters. In some embodiments, not all of the storage space of cluster storage construct 102 must be allocated in a mapped cluster, e.g., an example 8×8 cluster storage construct 102 can comprise only one 4×4 mapped cluster with the rest of cluster storage construct 102 being unallocated, differently allocated, etc.

In some embodiments, a mapped cluster can comprise storage space from more than one real cluster, e.g., first CSC 110 through L-th CSC 118 of cluster storage construct 102. In some embodiments, a mapped cluster can comprise storage space from real nodes, e.g., first cluster node component 130, etc., in different geographical areas. In some embodiments, a mapped cluster can comprise storage space from more than one real cluster in more than one geographic location. As an example, a mapped cluster can comprise storage space from a cluster having hardware nodes in a data center in Denver, e.g., where first CSC 110 is embodied in hardware of a Denver data center. In a second example, a mapped cluster can comprise storage space from a first cluster having hardware nodes in a first data center in Denver and from a second cluster also having hardware nodes in the first data center in Denver e.g., where first CSC 110 and L-th CSC 118 are embodied in hardware of a Denver data center. As a further example, a mapped cluster can comprise storage space from both a cluster having hardware nodes in a first data center in Denver and a second data center in Denver e.g., where first CSC 110 is embodied in first hardware of a first Denver data center and where L-th CSC 118 is embodied in second hardware of a second Denver data center. As a further example, a mapped cluster can comprise storage space from a first cluster having hardware nodes in a first data center in Seattle, Wash., and a second data center having hardware nodes in Tacoma, Wash., e.g., where first CSC 110 is embodied in first hardware of a first Seattle data center and where L-th CSC 118 is embodied in second hardware of a second Tacoma data center. As another example, a mapped cluster can comprise storage space from a first cluster having hardware nodes in a first data center in Houston, Tex., and a second cluster having hardware nods in a data center in Mosco, Russia e.g., where first CSC 110 is embodied in first hardware of a first Houston data center and where L-th CSC 118 is embodied in second hardware of a second Mosco data center.

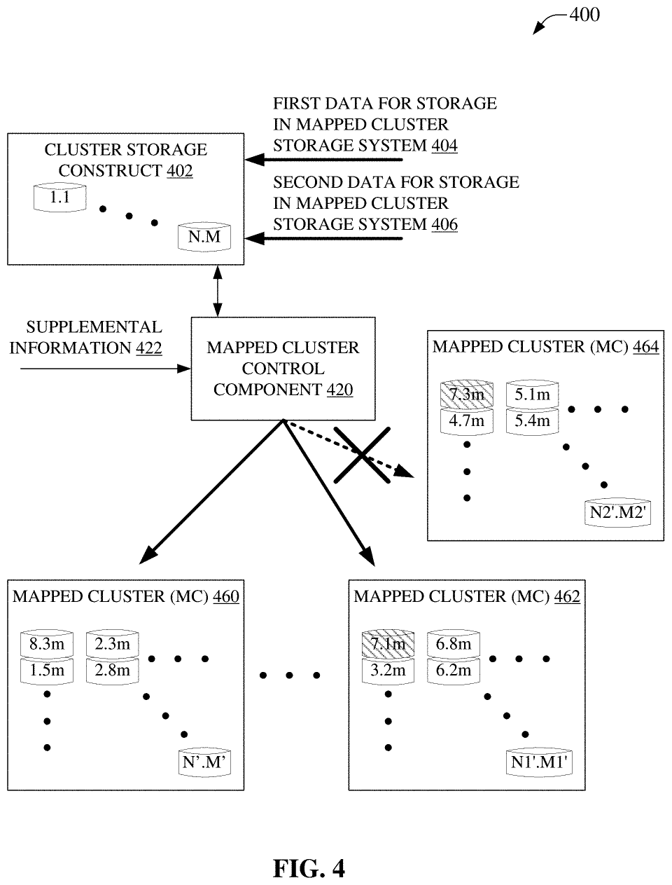

In an aspect, a mapped cluster control component, e.g., 220-620, etc., can allocate storage space of cluster storage component 102 based on an indicated level of granularity. In an aspect, this indicated level of granularity can be determined based on an amount of data to store, a determined level of storage space efficiency for storing data 104, a customer/subscriber agreement criterion, an amount of storage in cluster storage construct 102, network/computing resource costs, wherein costs can be monetary costs, heat costs, energy costs, maintenance costs, equipment costs, real property/rental/lease cost, or nearly any other costs. In an aspect, these types of information can be termed ‘supplemental information’, e.g., 222-422, etc., and said supplemental information can be used to allocate mapped storage space in a mapped cluster. In some embodiments, allocation can be unconstrained, e.g., any space of cluster storage component 102 can be allocated into a mapped cluster. In other embodiments, constraints can be applied, e.g., a constraint can be employed by a mapped cluster control component to select or reject the use of some storage space of cluster storage construct 102 when allocating a mapped cluster. As an example, see FIG. 4, a constraint can restrict allocating two mapped clusters that each use a disk from the same real node, because difficulty accessing the real node can result in effects on two mapped clusters. Other constraints can be readily appreciated, for example, based on a type of data redundancy schema, based on available/use storage space, based on network/computing resource costs, etc., and all such constraints are within the scope of the instant disclosure even where not recited for clarity and brevity.

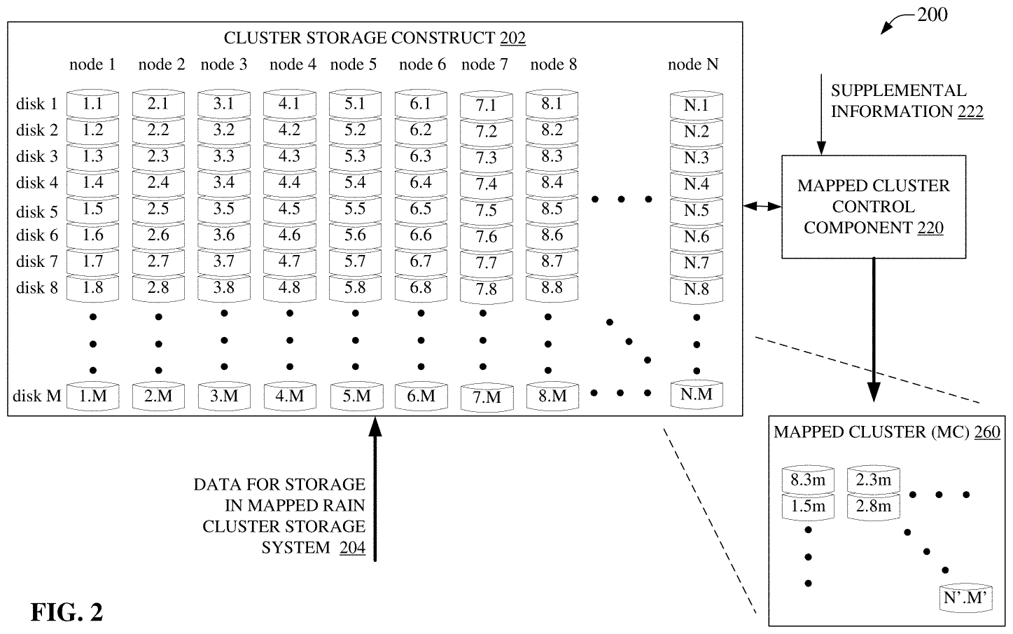

FIG. 2 is an illustration of a system 200, which can enable storage of data via a mapped cluster in a mapped redundant array of independent nodes, in accordance with aspects of the subject disclosure. System 200 can comprise cluster storage construct 202 that can be the same as, or similar to, cluster storage construct 102. Cluster storage construct 202 is illustrated at the disk and node level for ease of understating, e.g., disk 1.1 of disk 1 and node 1, for example, can be embodied in first disk component 140, disk 2.1, for example, can be embodied in first disk component 150, disk N.M, for example, can be embodied in a disk component of L-th CSC 118, etc. As is illustrated in this example embodiment, cluster storage construct 202 can comprise N nodes of M disks, e.g., disk 1,1 to N.M, etc.

Mapped cluster control component 220 can be communicatively coupled to, or be included in, cluster storage construct 202. Mapped cluster control component 220 can allocate mapped cluster (MC) 260, which can logically embody storage comprised in cluster storage construct 202. In an embodiment, MC 260 can be allocated based on supplemental information 222. As an example, supplemental information 222 can indicate a first amount of storage is needed and mapped cluster control component 220 can determine a number of, and identity of, disks of cluster storage construct 202 that meet the first amount of storage. This example mapped cluster control component 220 can accordingly allocate the identified disks as MC 260, e.g., disk 8.3m can correlate to an allocation of disk 8.3, 2.3m can correlate to an allocation of disk 2.3, . . . , disk N′.M′ can correlate to an allocation of disk N.M, etc.

Mapped cluster control component 220 can facilitate storage of data 204 via MC 260 in the allocated storage areas of cluster storage construct 202. As such, data 204 can be stored in a more granular storage space than would conventionally be available, e.g., conventionally all disks of node 1 can be used to store data 204 even where the 1 to M disk available storage space can far exceed an amount of storage needed, e.g., as indicated by the above example first amount of storage. As such, by mapping portions of a disk from a node into MC 260, a lesser amount of storage space can be made available for storing the example first amount of storage. As an example, where a conventional storage cluster can allocate a minimum block of 1.2 petabytes, this can far exceed the example first amount of storage, such as where the first amount of storage can be related to storing a log file, moving data units from legacy systems that employed smaller storage unit sizes, etc., and accordingly, allocating and facilitating storage of data into MC 260, where MC 260 can have minimum block sizes less than the example 1.2 petabytes, can be desirable.

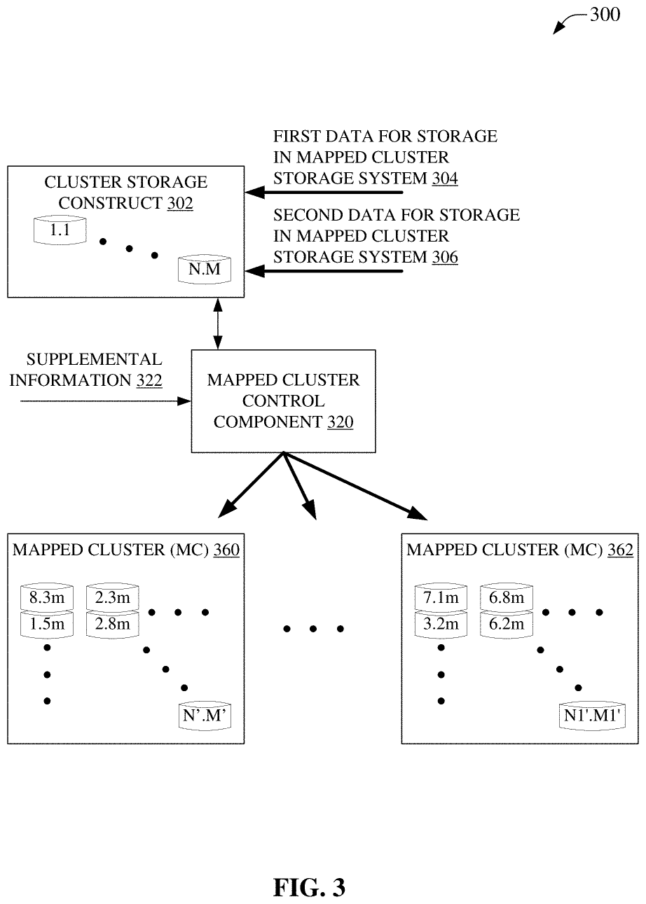

FIG. 3 is an illustration of a system 300, which can facilitate storage of data in a plurality of mapped clusters via a mapped redundant array of independent nodes, in accordance with aspects of the subject disclosure. System 300 can comprise cluster storage construct 302 that can comprise disk portions 1.1 to N.M in a manner that is the same as, or similar to, cluster storage construct 202. Mapped cluster control component 320 can allocate one or more MC, e.g., MC 360-362, etc. In an embodiment, allocation of MC 360-362 can be based on supplemental information 322 received by mapped cluster control component 320.

Mapped cluster 360 can comprise, for example, disk portion 8.3m, 2.3m, 1.5m, 2.8m, . . . , N′.M′ and mapped cluster 362 can comprise, for example, disk portion 7.1m, 6.8m, 3.2m, 6.2m, . . . , N1′.M1′. The example disk portions can map back to corresponding disk portion of cluster storage construct 302, e.g., 8.3m can map to 8.3 of cluster storage construct 302 (not illustrated, but see 8.3 of FIG. 2, etc.), etc. Incoming data for storage, e.g., first data 304 and second data 306, etc., can then be stored according to the mapping of MC 360-362 based on one or more indications from mapped cluster control component 320, e.g., mapped cluster control component 320 can orchestrate or facilitate storage of first data 304, second data 306, etc., into the appropriate disk portion of MC 360-362, etc.

In an embodiment, the size of MC 360 can be the same or different from the size of MC 362. As an example, MC 360 can be allocated based on a first amount of storage, related to storing first data 304, and MC 362 can be allocated based on a second amount of storage, related to storing first data 306. In an aspect the corresponding amounts of storage can be indicated via supplemental information 322, can be based on data 304-306 itself, etc. Moreover, in an embodiment, the size of a MC, e.g., MC 360-362, etc., can be dynamically adapted by mapped cluster control component 320, e.g., as data 304 transitions a threshold level, such as an amount of space occupied in MC 360, an amount of unused space in MC 360, etc., disk portions can be added to, or removed from MC 360 by mapped cluster control component 320. Additionally, adjusting the size of an MC can be based on other occupancy of cluster storage construct 302, e.g., by MC 362, etc., adding disks to cluster storage construct 302, removing disks form cluster storage construct 302, etc. As an example, where MC 362 uses 90% of cluster storage construct 302, the maximum size of MC 360 can be limited to about 10% by mapped cluster control component 320. As another example, where additional disks are added to cluster storage construct 302, for example doubling the storage space thereof, mapped cluster control component 320 can correspondingly increase the size of MC 360. As a further example, where a customer downgrades a storage plan, the lower amount of storage space purchased can be indicated in supplemental information 322 and mapped cluster control component 320 can correspondingly reduce the storage space, e.g., remove disk portions, from MC 360-362, etc.

In some embodiments, mapped cluster control component 320 can allocate disk portions based on other supplemental information 322. As an example, where cluster storage construct 302 comprises high cost storage, again cost can be monetary or other costs, and low cost storage, mapped cluster control component 320 can rank the available storage. This can enable mapped cluster control component 320, for example, to allocate the low cost storage into MC 360-362 first. In another example, the rank can allow mapped cluster control component 320 to allocate higher cost storage, such as where cost corresponds to speed of access, reliability, etc., to accommodate clients that are designated to use the higher ranked storage space, such as a client that pays for premium storage space can have their data stored in an MC that comprises higher ranked storage space.

FIG. 4 is an illustration of a system 400, which can enable constrained storage of data in a mapped redundant array of independent nodes, in accordance with aspects of the subject disclosure. System 400 can comprise cluster storage construct 402 that can comprise disk portions 1.1 to N.M in a manner that is the same as, or similar to, cluster storage construct 202, 302, etc. Mapped cluster control component 420 can allocate one or more MC, e.g., MC 460-462, etc., but can prevent allocation of MC 464. In an embodiment, allocation of MC 460-462 can be based on supplemental information 422 received by mapped cluster control component 420. Similarly, attempted allocation of MC 464 can be based on supplemental information 422. However, allocation of MC 464 can be defeated based on one or more allocation constraints, as are discussed herein.

In an embodiment, mapped cluster 460 can comprise, for example, disk portion 8.3m, 2.3m, 1.5m, 2.8m, . . . , N′.M′ and mapped cluster 462 can comprise, for example, disk portion 7.1m, 6.8m, 3.2m, 6.2m, . . . , N1′.M1′. The example disk portions can map back to corresponding disk portion of cluster storage construct 402, e.g., 8.3m can map to 8.3 of cluster storage construct 402 (not illustrated, but see 8.3 of FIG. 2, etc.), etc. Incoming data for storage, e.g., first data 404 and second data 406, etc., can then be stored according to the mapping of MC 460-462 based on one or more indications from mapped cluster control component 420, e.g., mapped cluster control component 420 can orchestrate or facilitate storage of first data 404, second data 406, etc., into the appropriate disk portion of MC 460-462, etc.

Mapped cluster control component 420 can prevent allocation of MC 464 based on a constraint. In an aspect, a constraint on allocation can be related to preventing data loss events, e.g., applying best practices to data storage. It will be noted that where disk portions of one real node of cluster storage construct 402 are allocated to different mapped clusters, for example, MC 462 can comprise disk portion 7.1m, corresponding to node 7 disk 1 of cluster storage construct 402, and MC 464 attempts to allocate disk portion 7.3m, corresponding to node 7 disk 3 of cluster storage construct 402, that an access restriction to node 7 of cluster storage construct 402 would impact both MC 462 and MC 464. As such, an example constraint can restrict allocating a disk portions of a first node of cluster storage construct 402 to more than one mapped cluster. Where this example constraint is applied by mapped cluster control component 420, allocation of MC 464 can be prevented. However, where MC 464 allocated a disk portion from node 9 (not illustrated) of cluster storage construct 402 in lieu of disk portion 7.3m, the constraint would not be violated by the illustrated example and MC 464 could be allocated by mapped cluster component 420. Other constraints will be readily appreciated and are within the scope of the instant disclosure, even where not explicitly recited for the sake of clarity and brevity.

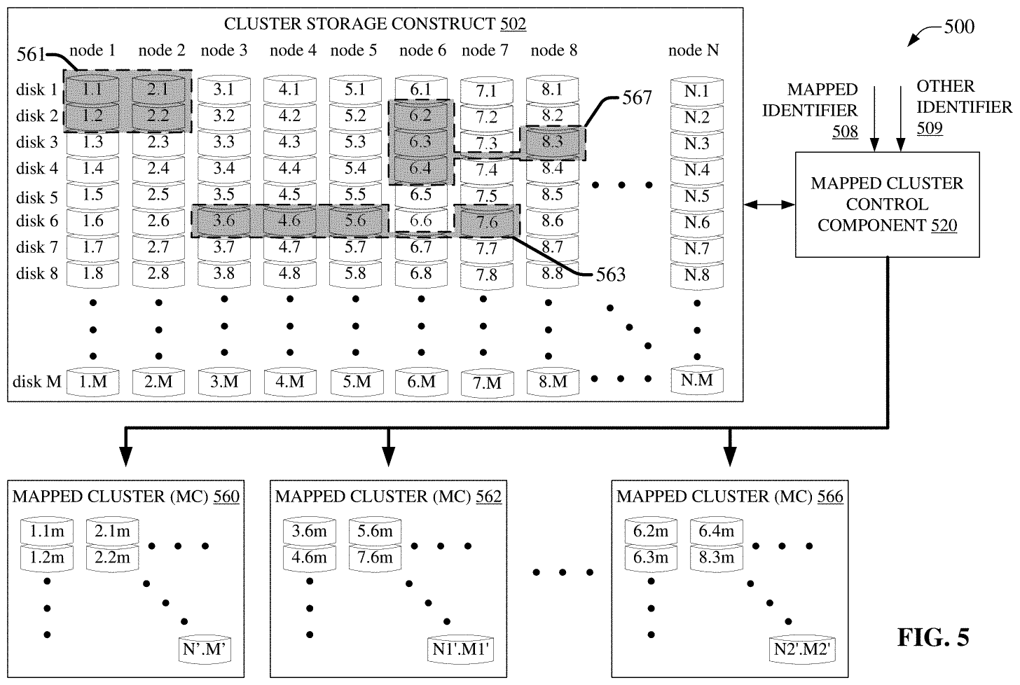

FIG. 5 is an illustration of a system 500, which can enable constrained storage of data in a mapped redundant array of independent nodes via a plurality of example mapped clusters, in accordance with aspects of the subject disclosure. System 500 can comprise cluster storage construct 502 that can comprise disk portions 1.1 to N.M in a manner that is the same as, or similar to, cluster storage construct 202, 302, 402, etc. Mapped cluster control component 520 can allocate one or more MC, e.g., MC 560-566, etc.

Mapped cluster control component 520 can receive mapped identifier 508, other identifier 509, etc., which identifiers can enable directing data, e.g., data 104, 204, 304, 306, 404, 406, etc., to disk portions of cluster storage construct 502 corresponding to a relevant mapped cluster, e.g., MC 560-566, etc. Mapped identifier 508 can be comprised in received data, e.g., data 104-406, etc., for example, a customer can indicate mapped identifier 508 when sending data for storage in a mapped cluster. Mapped identifier 508 can also be included in a request to access data. In an embodiment, mapped identifier 508 can indicate a logical location in a mapped cluster that can be translated by mapped cluster control component 520 to enable access to the a real location of a disk portion in cluster storage construct 502. This can allow use of a logical location to access, e.g., read, write, delete, copy, etc., data from a physical data store. Other identifier 509 can similarly be received. Other identifier can indicate a real location rather than a mapped location, e.g., mapped cluster control component 520 can provide a real location based on the mapping of a mapped cluster, and such real location can then be used for future access to the real location corresponding to the mapped location.

In an embodiment, mapped cluster 560 can comprise, for example, disk portion 1.1m, 1.2m, 2.1m, 2.2m, . . . , N′.M′, mapped cluster 562 can comprise, for example, disk portion 3.6m, 4.6m, 5.6m, 7.6m, . . . , N1′.M1′, and mapped cluster 566 can comprise, for example, disk portion 6.2m, 6.3m, 6.4m, 8.3m, . . . , N2′.M2′. The example disk portions can map back to corresponding disk portion of cluster storage construct 502, e.g., MC 560 can map to disk portions 561 of cluster storage construct 502, MC 562 can map to disk portions 563 of cluster storage construct 502, MC 566 can map to disk portions 567 of cluster storage construct 502, etc. As can be observed, example system 500 does not violate the example constraints discussed in regard to system 400, e.g., no node contributes storage space to and two mapped clusters. Additionally, system 500 illustrates that mapped clusters can comprise contiguous portions of cluster storage construct 502, e.g., disk portions of 561 are illustrated as contiguous. System 500 further illustrates non-contiguous allocation, e.g., disk portions of 563 are illustrated as contiguous for portions 3.6, 4.6, and 5.6, but non-contiguous with disk portion 7.6. Disk portions of 563 are also illustrative of use of only one disk of cluster storage construct 502, e.g., all allocated disk portions of 563 are from disk 6 across four non-contiguous nodes. Disk portions 567 are similar non-contiguous and further illustrate that multiple disks of a node of cluster storage construct 502 can be comprised in a mapped cluster, e.g., disks 2-4 of node 6 of cluster storage construct 502 can be comprised in MC 566. It will be noted that other allocations can also be made without departing from the scope of the disclosed subject matter, e.g., another unillustrated mapped cluster could comprise disk portions from cluster storage construct 502 that are each from different nodes and different disks, etc., which allocations have not been explicitly recited for the sake of clarity and brevity.

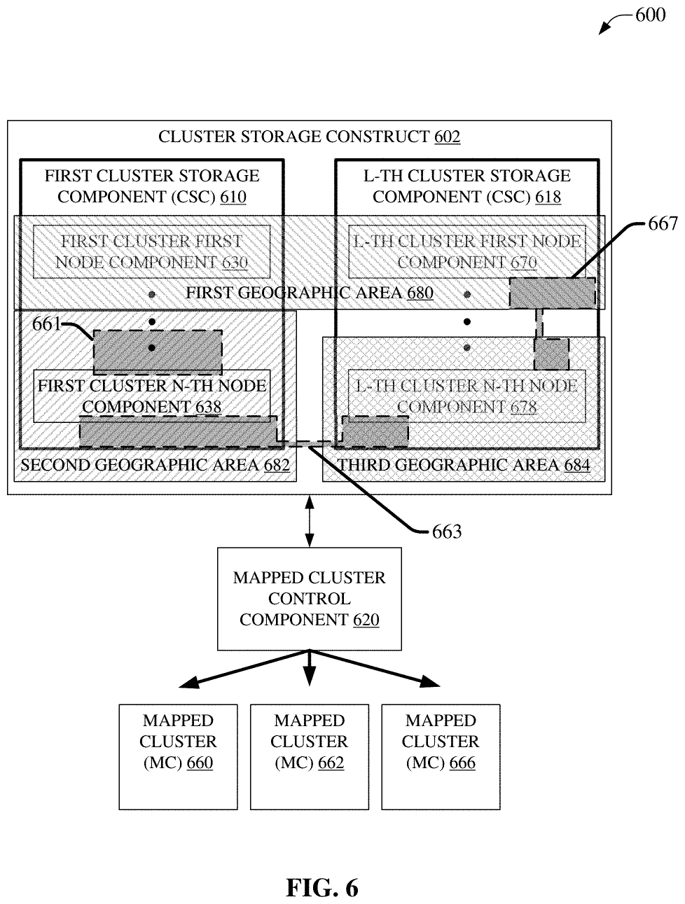

FIG. 6 is an illustration of a system 600 that can storage of data in a mapped redundant array of independent nodes employing storage hardware that can be in different geographic areas, in accordance with aspects of the subject disclosure. System 600 can comprise cluster storage construct 602 that can comprise disk portions in a manner that is the same as, or similar to, cluster storage construct 202, 302, 402, 502, etc. These disk portions can be comprised in node components, e.g., first cluster first node component 630 through first cluster N-th node component 638, L-th cluster first node component 670 through L-th cluster N-th node component 678, etc. Further, the Node components, e.g., 630-638, 679-678, etc., can be comprised in CSCs, e.g., first CSC 610, L-th CSC 618, etc. Moreover, portions of CSC comprising node components can be comprised in one or more geographic areas, e.g., first geographic area 680, second geographic area 682, third geographic area 684, etc. As such, cluster storage construct 602 can comprise real clusters that can comprise nodes having storage devices in one or more geographic area, e.g., cluster storage construct 602 can comprise a first cluster, e.g., via first cluster component 610 that can have storage devices in first geographic area 680, e.g., via first cluster first node component 630, and in second geographic area 682, e.g., via first cluster N-th node component 638, etc. This illustrates that the hardware, e.g., disks, etc., for the example first cluster can be located in two different geographic locations. In other unillustrated embodiments, a cluster can have all corresponding hardware in a single geographic location, in more than two geographic locations, etc.

Mapped cluster control component 620 can allocate one or more MC, e.g., MC 660-666, etc. In an embodiment, allocation of MC 660-666 can be based on supplemental information, e.g., 222-422, etc., received by mapped cluster control component 620. In an embodiment, mapped cluster 660 can comprise, for example, disk portions 661, mapped cluster 662 can comprise, for example, disk portions 663, mapped cluster 666 can comprise, for example, disk portions 667, etc. Disk portions 661, in some embodiments, can be entirely in a one cluster and in one geographic location, e.g., disk portion 661 can be embodied in first CSC 610 hardware located entirely within second geographic area 682. As an example, first CSC 610 can comprise storage devices located at a Boston data center, e.g., second geographic area 682, and disk portions of clusters, e.g., via cluster components of the Boston data center, can be allocated to MC 660. Disk portions 663, in some embodiments, can span more than one real cluster, e.g., via first CSC 610 and L-th CSC 618 and still be in one geographic location, e.g., disk portion 663 can be embodied in first CSC 610 and L-th CSC 618 hardware located entirely within second geographic area 682. As an example, first CSC 610 can comprise storage devices located at a Boston data center and L-th CSC 618 can also comprise storage devices located at the Boston data center. Disk portions 667, in some embodiments, can be in one real cluster, e.g., via L-th CSC 618 and also be in more than one geographic location, e.g., disk portion 667 can be embodied in L-th CSC 618 hardware, and L-th CSC 618 hardware can be located in first and third geographic areas, e.g., 680 and 684. As an example, L-th CSC 618 can also comprise storage devices located in Dallas and Miami and disk portions 667 from these different geographic areas can be mapped to MC 666.

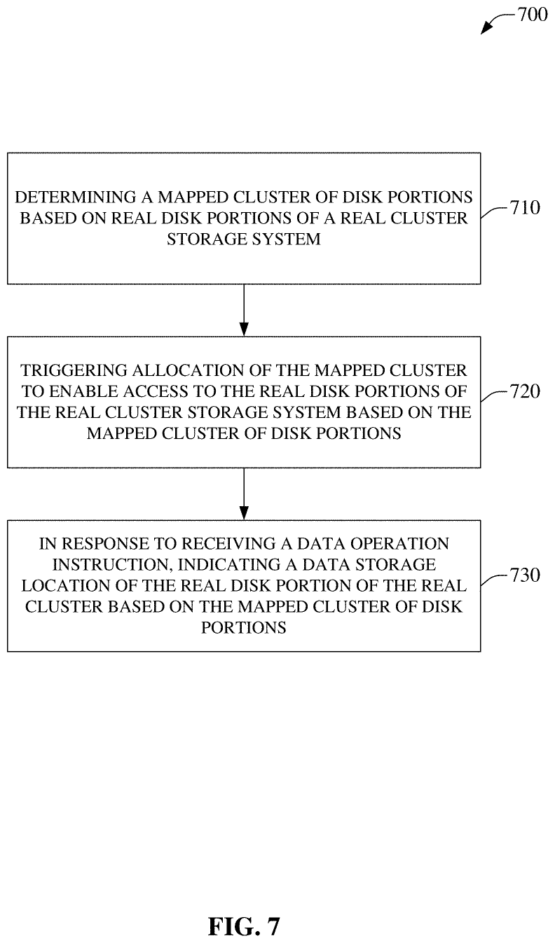

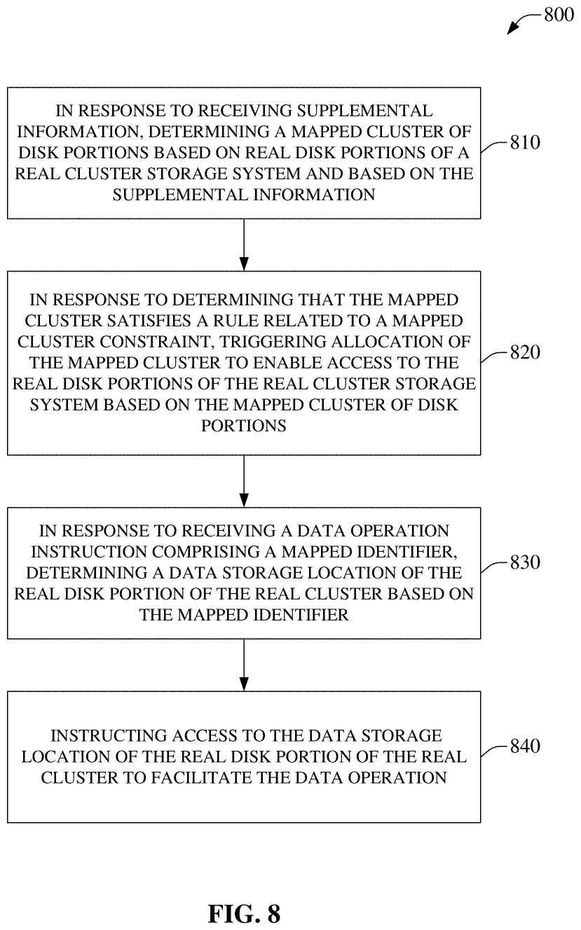

In view of the example system(s) described above, example method(s) that can be implemented in accordance with the disclosed subject matter can be better appreciated with reference to flowcharts in FIG. 7-FIG. 8. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 7 is an illustration of an example method 700, which can facilitate storage of data in a mapped redundant array of independent nodes, in accordance with aspects of the subject disclosure. At 710, method 700 can comprise determining a mapped cluster of disk portions. The determining can be based on real disk portions of a real cluster storage system. In an embodiment, a portion of a real disk can be comprised in a real node that can be comprised in a real cluster and, furthermore, a portion of the real disk can correspond to a portion of a mapped disk, a mapped disk can comprise one or more portions of one or more real disks, a mapped node can comprise one or more portions of one or more real nodes, a mapped cluster can comprise one or more portions of one or more real clusters, etc. Accordingly, in an embodiment, cluster storage system can support a mapped cluster enabling data to be stored on one or more disk portion, e.g., 140 through 148, 150-158, disk portions 1.1 through N.M of system 200, 300, 400, 500, etc., according to a mapped cluster schema. In an aspect, a mapped cluster control component, e.g., mapped cluster control component 220-620, etc., can coordinate storage of data on storage elements, or portions thereof, of a real cluster of cluster storage system according to a mapping of a mapped cluster, e.g., mapped cluster control component 220-620, etc., can indicate where in cluster storage system data is to be stored, cause data to be stored at a location in in cluster storage system based on the mapping of the mapped cluster, etc.

Accordingly, a mapped cluster can be comprised in one or more portions of one or more real cluster. The mapped cluster can be N′ nodes by M′ disks in size and the one or more real clusters of cluster storage system can be N nodes by M disks in size, where N′ can be less than, or equal to, N, and M′ can be less than, or equal to, or greater than, M. In these embodiments, the mapped cluster can be smaller than cluster storage system size. In some embodiments, a mapped cluster can comprise storage space from more than one real cluster of the real cluster storage system. In some embodiments, a mapped cluster can comprise storage space from real nodes in different geographical areas. In some embodiments, a mapped cluster can comprise storage space from more than one real cluster in more than one geographic location.

At 720, method 700 can comprise triggering allocation of the mapped cluster. The allocation of the mapped cluster can enable access to the real disk portion of the real cluster storage system. Access can be based on the mapped cluster disk portions. In an aspect, the mapping of the mapped cluster disk portions to the real cluster real disk portions can enable accessing a real data storage location, e.g., to read, write, erase, alter, etc., data corresponding to the real data storage location based on a corresponding mapped disk portion.

Method 700, at 730, can indicate a data storage location in response to receiving a data operation instruction. At this point method 700 can end. In an aspect, the data storage location can be comprised in a real disk portion of the real cluster. The data location can be based on the mapped cluster of the disk portions.

In an aspect, a mapped cluster can be allocated based on an indicated level of granularity. In an aspect, this indicated level of granularity can be determined based on an amount of data to store, a determined level of storage space efficiency for storing data, a customer/subscriber agreement criterion, an amount of storage in cluster storage system, network/computing resource costs, wherein costs can be monetary or other costs, etc., e.g., supplemental information 222-422, etc. The supplemental information can be used in the allocating mapped storage space for the mapped cluster. In some embodiments, allocation can be unconstrained, while in other embodiments, constraints can be applied when allocating a mapped cluster, see FIG. 4 illustrating a constraint against two mapped clusters that each use a disk from the same real node due to a potential data event to two mapped clusters resulting from difficulty accessing the real node. Other constraints can be readily appreciated, for example, based on a type of data redundancy schema, based on available/use storage space, based on network/computing resource costs, etc., and all such constraints are within the scope of the instant disclosure even where not recited for clarity and brevity.

FIG. 8 is an illustration of an example method 800, which can enable storage of data in a mapped redundant array of independent nodes, in accordance with aspects of the subject disclosure. At 810, method 800, in response to receiving supplemental information, can comprise determining a mapped cluster of disk portions. The determining can be based on real disk portions of a real cluster storage system and the supplemental information. In an aspect, the supplemental information can alter a level of granularity of the mapped cluster. In an aspect, the supplemental information can be an amount of data to store, a determined level of storage space efficiency for storing data, a customer/subscriber agreement criterion, an amount of storage in cluster storage system, network/computing resource costs, wherein costs can be monetary or other costs, etc. In some embodiments, determining the mapped cluster can be unconstrained or subject to constraints as disclosed herein.

At 820, method 800 can comprise triggering allocation of the mapped cluster in response to determining that the determined mapped cluster satisfies a rule related to a mapped cluster constraint. The allocation of the mapped cluster can enable access to the real disk portion of the real cluster storage system. Access can be based on the mapped cluster disk portions. In an aspect, the mapping of the mapped cluster disk portions to the real cluster real disk portions can enable accessing a real data storage location, e.g., to read, write, erase, alter, etc., data corresponding to the real data storage location based on a corresponding mapped disk portion.

Method 800, at 830, can comprise determining a data storage location in response to receiving a data operation instruction. The data storage operation instruction can comprise a mapped identifier. The mapped identifier, for example, can be indicated by a customer when sending data for storage in a mapped cluster, when requesting access to data in a mapped cluster, etc. In an embodiment, the mapped identifier can indicate a logical location in a mapped cluster that can be translated to the real data storage location of a real disk portion of the real cluster to enable access to that data storage location based on the mapped cluster. This can allow use of a logical location to access, e.g., read, write, delete, copy, etc., data from a physical data store. In other embodiments, other identifiers can indicate a real location rather than a mapped location, e.g., a mapped cluster control component can provide a real location based on the mapping of a mapped cluster, and such real location can then be used for future access to the real location corresponding to the mapped location.

At 840, method 800 can comprise instructing access to the data storage location of the real disk portion of the real cluster to facilitate the data operation. At this point method 800 can end. A mapped cluster, e.g., a mapped RAIN cluster, can comprise a logical allocation of real storage devices. In a mapped cluster can be defined to enable more granular use of the real cluster in contrast to conventional storage techniques. In an aspect, a mapped cluster can comprise nodes that provide data redundancy, which, in an aspect, can allow for failure of a portion of one or more nodes of the mapped cluster without loss of access to stored data, can allow for removal/addition of one or more nodes from/to the mapped cluster without loss of access to stored data, etc. In an embodiment, software, firmware, etc., can hide the abstraction of mapping nodes in a mapped RAIN system according to method 800, e.g., the group of nodes can appear to be a block of data storage even where, for example, it can be spread across multiple portions of one or more real disks, multiple real groups of hardware node, multiple real clusters of hardware nodes, multiple geographic locations, etc. In an embodiment, one mapped node is expected to manage disks of different real nodes. Similarly, in an embodiment, disks of one real node are expected to be managed by mapped nodes of different mapped RAIN clusters. In some embodiments, a mapped cluster can comprise storage space from more than one real cluster. In some embodiments, a mapped cluster can comprise storage space from real nodes in different geographical areas. In some embodiments, a mapped cluster can comprise storage space from more than one real cluster in more than one geographic location

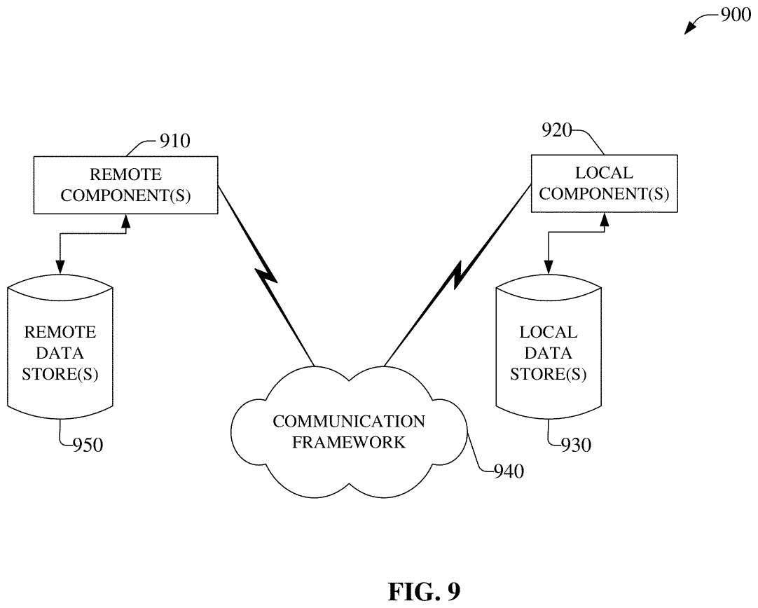

FIG. 9 is a schematic block diagram of a computing environment 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a remotely located cluster storage device, e.g., embodied in a cluster storage construct, such as 202-602, etc., connected to a local mapped cluster control component, e.g., 220-620, etc., via communication framework 940. Communication framework 940 can comprise wired network devices, wireless network devices, mobile devices, wearable devices, radio access network devices, gateway devices, femtocell devices, servers, etc.

The system 900 also comprises one or more local component(s) 920. The local component(s) 920 can be hardware and/or software (e.g., threads, processes, computing devices). In some embodiments, local component(s) 920 can comprise a local mapped cluster control component, e.g., 220-620, etc., connected to a remotely located storage devices via communication framework 940. In an aspect the remotely located storage devices can be embodied in a cluster storage construct, such as 202-602, etc.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940. As an example, information corresponding to a mapped data storage location can be communicated via communication framework 940 to other devices, e.g., to facilitate access to a real data storage location, as disclosed herein.

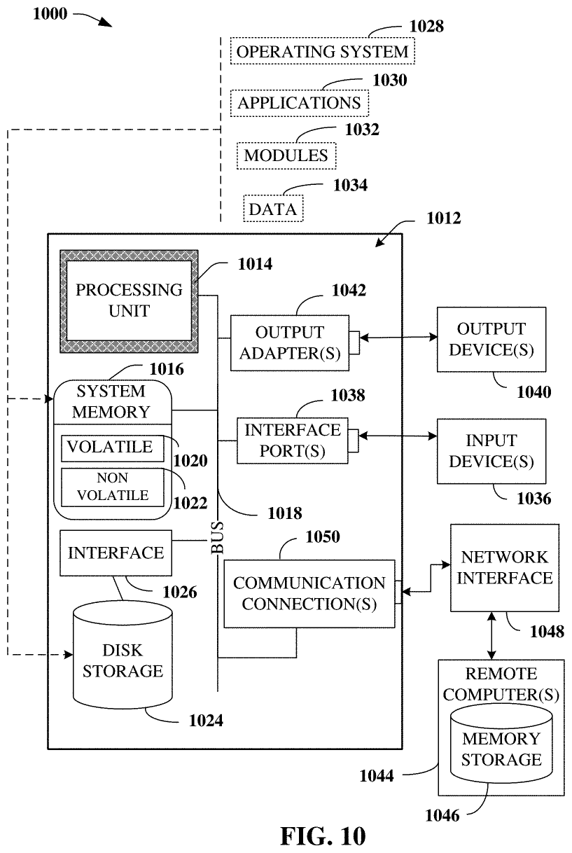

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It is noted that the memory components described herein can be either volatile memory or nonvolatile memory, or can comprise both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, comprised in a cluster storage construct, such as 202-602, etc., in mapped cluster control component, e.g., 220-620, etc., can comprise a processing unit 1014, a system memory 1016, and a system bus 1018. System bus 1018 couples system components comprising, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) comprising a memory bus or a memory controller, a peripheral bus or an external bus, and/or a local bus using any variety of available bus architectures comprising, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (Institute of Electrical and Electronics Engineers 1194), and small computer systems interface.

System memory 1016 can comprise volatile memory 1020 and nonvolatile memory 1022. A basic input/output system, containing routines to transfer information between elements within computer 1012, such as during start-up, can be stored in nonvolatile memory 1022. By way of illustration, and not limitation, nonvolatile memory 1022 can comprise read only memory, programmable read only memory, electrically programmable read only memory, electrically erasable read only memory, or flash memory. Volatile memory 1020 comprises read only memory, which acts as external cache memory. By way of illustration and not limitation, read only memory is available in many forms such as synchronous random access memory, dynamic read only memory, synchronous dynamic read only memory, double data rate synchronous dynamic read only memory, enhanced synchronous dynamic read only memory, SynchLink dynamic read only memory, Rambus direct read only memory, direct Rambus dynamic read only memory, and Rambus dynamic read only memory.

Computer 1012 can also comprise removable/non-removable, volatile/non-volatile computer storage media. FIG. 10 illustrates, for example, disk storage 1024. Disk storage 1024 comprises, but is not limited to, devices like a magnetic disk drive, floppy disk drive, tape drive, flash memory card, or memory stick. In addition, disk storage 1024 can comprise storage media separately or in combination with other storage media comprising, but not limited to, an optical disk drive such as a compact disk read only memory device, compact disk recordable drive, compact disk rewritable drive or a digital versatile disk read only memory. To facilitate connection of the disk storage devices 1024 to system bus 1018, a removable or non-removable interface is typically used, such as interface 1026.

Computing devices typically comprise a variety of media, which can comprise computer-readable storage media or communications media, which two terms are used herein differently from one another as follows.

Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, read only memory, programmable read only memory, electrically programmable read only memory, electrically erasable read only memory, flash memory or other memory technology, compact disk read only memory, digital versatile disk or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can comprise non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium. As such, for example, a computer-readable medium can comprise executable instructions stored thereon that, in response to execution, can cause a system comprising a processor to perform operations, comprising determining a mapped cluster schema, altering the mapped cluster schema until a rule is satisfied, allocating storage space according to the mapped cluster schema, and enabling a data operation corresponding to the allocated storage space, as disclosed herein.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software comprises an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. In some embodiments, a user interface can allow entry of user preference information, etc., and can be embodied in a touch sensitive display panel, a mouse/pointer input to a graphical user interface (GUI), a command line controlled interface, etc., allowing a user to interact with computer 1012. Input devices 1036 comprise, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 comprise, for example, a serial port, a parallel port, a game port, a universal serial bus, an infrared port, a Bluetooth port, an IP port, or a logical port associated with a wireless service, etc. Output device(s) 1040 use some of the same type of ports as input device(s) 1036.

Thus, for example, a universal serial busport can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 comprise, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, a cloud service, code executing in a cloud-computing environment, a workstation, a microprocessor-based appliance, a peer device, or other common network node and the like, and typically comprises many or all of the elements described relative to computer 1012. A cloud computing environment, the cloud, or other similar terms can refer to computing that can share processing resources and data to one or more computer and/or other device(s) on an as needed basis to enable access to a shared pool of configurable computing resources that can be provisioned and released readily. Cloud computing and storage solutions can store and/or process data in third-party data centers which can leverage an economy of scale and can view accessing computing resources via a cloud service in a manner similar to a subscribing to an electric utility to access electrical energy, a telephone utility to access telephonic services, etc.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local area networks and wide area networks. Local area network technologies comprise fiber distributed data interface, copper distributed data interface, Ethernet, Token Ring and the like. Wide area network technologies comprise, but are not limited to, point-to-point links, circuit-switching networks like integrated services digital networks and variations thereon, packet switching networks, and digital subscriber lines. As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can comprise, for example, internal and external technologies such as modems, comprising regular telephone grade modems, cable modems and digital subscriber line modems, integrated services digital network adapters, and Ethernet cards.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. Moreover, the use of any particular embodiment or example in the present disclosure should not be treated as exclusive of any other particular embodiment or example, unless expressly indicated as such, e.g., a first embodiment that has aspect A and a second embodiment that has aspect B does not preclude a third embodiment that has aspect A and aspect B. The use of granular examples and embodiments is intended to simplify understanding of certain features, aspects, etc., of the disclosed subject matter and is not intended to limit the disclosure to said granular instances of the disclosed subject matter or to illustrate that combinations of embodiments of the disclosed subject matter were not contemplated at the time of actual or constructive reduction to practice.

Further, the term “include” is intended to be employed as an open or inclusive term, rather than a closed or exclusive term. The term “include” can be substituted with the term “comprising” and is to be treated with similar scope, unless otherwise explicitly used otherwise. As an example, “a basket of fruit including an apple” is to be treated with the same breadth of scope as, “a basket of fruit comprising an apple.”

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities, machine learning components, or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks comprise broadcast technologies (e.g., sub-Hertz, extremely low frequency, very low frequency, low frequency, medium frequency, high frequency, very high frequency, ultra-high frequency, super-high frequency, extremely high frequency, terahertz broadcasts, etc.); Ethernet; X.25; powerline-type networking, e.g., Powerline audio video Ethernet, etc.; femtocell technology; Wi-Fi; worldwide interoperability for microwave access; enhanced general packet radio service; second generation partnership project (2G or 2GPP); third generation partnership project (3G or 3GPP); fourth generation partnership project (4G or 4GPP); long term evolution (LTE); fifth generation partnership project (5G or 5GPP); third generation partnership project universal mobile telecommunications system; third generation partnership project 2; ultra mobile broadband; high speed packet access; high speed downlink packet access; high speed uplink packet access; enhanced data rates for global system for mobile communication evolution radio access network; universal mobile telecommunications system terrestrial radio access network; or long term evolution advanced. As an example, a millimeter wave broadcast technology can employ electromagnetic waves in the frequency spectrum from about 30 GHz to about 300 GHz. These millimeter waves can be generally situated between microwaves (from about 1 GHz to about 30 GHz) and infrared (IR) waves, and are sometimes referred to extremely high frequency (EHF). The wavelength (λ) for millimeter waves is typically in the 1-mm to 10-mm range.

The term “infer” or “inference” can generally refer to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference, for example, can be employed to identify a specific context or action, or can generate a probability distribution over states of interest based on a consideration of data and events. Inference can also refer to techniques employed for composing higher-level events from a set of events and/or data. Such inference results in the construction of new events or actions from a set of observed events and/or stored event data, whether the events, in some instances, can be correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the processor, facilitate performance of operations, comprising:
in response to receiving a real cluster storage system criterion, determining a first mapped cluster schema;
allocating storage space of the real cluster storage system as a first mapped cluster based on the first mapped cluster schema; and
facilitating a data operation corresponding to a data storage location comprised in the real cluster storage system according to the first mapped cluster based on the first mapped cluster schema.

2. The system of claim 1, wherein the real cluster storage system comprises 1 to L real data storage clusters.

3. The system of claim 2, wherein a real data storage cluster of the 1 to L real data storage clusters comprises 1 to N hardware data storage nodes, wherein a hardware data storage node of the 1 to N hardware storage nodes comprises 1 to M data storage devices, and wherein the data storage location is comprised in a data storage device of the 1 to M data storage devices of the hardware data storage node of the 1 to N hardware data storage devices of the real data storage cluster of the 1 to L data storage clusters.

4. The system of claim 1, wherein the allocating the storage space of the real cluster is based on an overall amount of storage of the real cluster storage system.

5. The system of claim 1, wherein the allocating the storage space of the real cluster is based on an indication of an amount of data to be stored via the first mapped storage cluster.

6. The system of claim 1, wherein the allocating the storage space of the real cluster is based on an indication of an amount of data stored via a second mapped cluster allocated from the real cluster storage system.

7. The system of claim 1, wherein the operations further comprise, in response to determining that a rule related to a constraint on disk portion allocation has been satisfied, preventing the allocating the storage space based on the first mapped cluster schema.

8. The system of claim 1, wherein the operations further comprise, in response to determining that a rule related to a constraint on disk portion allocation has been satisfied, altering the first mapped cluster schema prior to the allocating the storage space.

9. The system of claim 1, wherein the facilitating the data operation is based on information indicating a real data storage location being received in conjunction with receiving the data operation.

10. The system of claim 1, wherein the facilitating the data operation is based on information indicating a mapped data storage location being received in conjunction with receiving the data operation.

11. The system of claim 1, wherein a first size of the first mapped cluster is a different size than a second size of a second mapped cluster.

12. The system of claim 1, wherein the operation further comprise:
in response to a change in an amount of data to be stored according to the first mapped cluster schema, altering the first mapped cluster schema, resulting in an updated mapped cluster schema; and
reallocating the storage space of the real cluster storage system based on the updated first mapped cluster schema, resulting in an updated first mapped cluster.

13. The system of claim 12, wherein the altering the first mapped cluster schema results in the updated first mapped cluster having more storage space than the first mapped cluster.

14. The system of claim 12, wherein the altering the first mapped cluster schema results in the updated first mapped cluster having less storage space than the first mapped cluster.

15. A method, comprising:
in response to receiving real cluster storage system criteria, allocating, by a system comprising a processor and a memory, storage space of the real cluster storage system as a first mapped cluster according to a determined first mapped cluster schema based on the real cluster storage system criteria; and
causing, by the system, a data operation to occur in the allocated storage space of the real cluster storage system according to the first mapped cluster and based on the first mapped cluster schema.

16. The method of claim 15, wherein the allocating the storage space is according to a determined first mapped cluster schema based on:
the real cluster storage system criteria,
a request for an indicated amount of storage space, and
a second mapped cluster schema corresponding to a second mapped cluster allocated from the storage space of the real cluster storage system.

17. The method of claim 15, wherein the receiving the real cluster storage system criteria comprises receiving an indication of storage space corresponding to a first storage device and a second storage device, wherein the first storage device is located in a first geographic area, and wherein the second storage device is located in a second geographic area different than the first geographic area.

18. A machine-readable storage medium, comprising executable instructions that, when executed by a processor, facilitate performance of operations, comprising:
determining a first mapped cluster schema based on a first request for first storage space in a real cluster storage system;
altering the first mapped cluster schema until the first mapped cluster schema is determined to satisfy a rule related to a mapped cluster constraint;
allocating the first storage space of the real cluster storage system as a first mapped cluster, according to the first mapped cluster schema, based on a criterion of the real cluster storage system; and
providing information enabling a data operation corresponding to the first mapped cluster to occur based on the first mapped cluster schema.

19. The machine-readable storage medium of claim 18, wherein the mapped cluster constraint indicates that disks of a first node of the real cluster storage system are unable to be used in more than one mapped cluster.

20. The machine-readable storage medium of claim 18, wherein the operations further comprise:
in response to an amount of unutilized space of the first storage space being determined to transition a threshold level, adapting the first mapped cluster schema to an updated first mapped cluster schema and reallocating the first storage space according to the updated first mapped cluster schema, resulting in an updated first storage space.
